(19) United States
(12) Patent Application Publication
(10) Pub. No.: US 2011/0167419 A1
(43) Pub. Date: Jul. 7, 2011

(54) INFORMATION PROCESSING APPARATUS AND CONTROL METHOD THEREOF

(75) Inventor: Akira Ishikawa, Machida-shi (JP)

(73) Assignee: CANON KABUSHIKI KAISHA, Tokyo (JP)

(21) Appl. No.: 12/974,461

(22) Filed: Dec. 21, 2010

(30) Foreign Application Priority Data
Jan. 6, 2010 (JP) 2010-001565

(51) Int. Cl. G06F 9/44

(52) U.S. Cl. 717/171

(57) ABSTRACT

An information processing apparatus is provided with a reception unit that receives, via a network, compressed difference files corresponding to respective regions of firmware that are to undergo an update process, a selection unit that selects a difference file of a size expandable in a second area, from the difference files received by the reception unit, a transition unit that transitions to a state where no jobs are received except for the update process, an expansion unit that expands the difference file selected by the selection unit in the second area, and an execution unit that executes the update process on the firmware after the transition to the state by the transition unit, by compressing the difference file expanded by the expansion unit and storing the compressed difference file in a first area.

### BACKGROUND OF THE INVENTION

1. Field of the Invention

The present invention relates to an information processing apparatus for optimizing a work area used in updating firmware, and a control method thereof.

2. Description of the Related Art

In order to store firmware efficiently in nonvolatile memory (for example, flash memory), information processing apparatuses that serve as embedded devices often employ a compressed read-only file system (for example, SquashFS). With such a read-only file system (hereinafter, compressed file system), it is necessary to create files in a generic file system, create a compressed file system using a prescribed compression logic, and mount the file system in a target system. Also, online update via a network is employed, since firmware needs to be updated promptly with the aim of improving security and the like. Further, in the case of a slow network connection or a high communication error rate, difference update that involves transferring only the portion to be updated rather than the entire firmware is employed, since a comparatively long time is needed to download update files for performing update. With such difference update, it is not common for a single file to be further divided before being transferred, given that a single file is often the smallest unit of an update portion, and also given the complexity of logic for reflecting difference and the difficulty in managing difference for each upgrade. Difference files are represented by a collection of files, and in the case where a plurality of updates are implemented at the same time, plural sets of difference files are handled as the update portion.

In a configuration that compresses the directories of a compressed file system, the smallest unit is an arbitrary directory and the largest unit is the entire file system. Therefore, a configuration in which a compressed file system is created in advance and transferred as difference files is not suitable, since the units of the update portion differ from the units of the compressed file system. Japanese Patent Laid-Open No. 2009-9392 proposes a configuration in which compressed files are expanded in RAM, difference files are reflected in RAM, and data in RAM is compressed in order to update the files of a compressed file system via a wireless network. With such a compressed file system, it is no longer necessary to recreate the compressed file system with a device in order to reflect the difference files. Japanese Patent Laid-Open No. 2003-108399 proposes a configuration for optimizing the download area in which received files are placed. According to this configuration, if a download area cannot be fixedly secured as a system, an area of nonvolatile memory that another function is using is dynamically acquired and used, and further if sufficient capacity cannot be acquired, the download can be interrupted, thus enabling efficient usage of nonvolatile memory to be achieved.

Here, in a system having a large number of functions (for example, image forming function, image reading function) such as a multifunction peripheral, the size of the compressed data of firmware is considerable (for example, several 100 MB). Also, in the case where firmware is expanded in RAM such as with Japanese Patent Laid-Open No. 2009-9392, an even larger amount of RAM needs to be secured (for example, max. of several gigabytes).

However, the amount of RAM used in a multifunction peripheral is extremely small in terms of cost (for example, 256 MB), and further the area usable as a work area for update is limited to a portion thereof (for example, approx. 100 MB). Thus, in the case of multifunction peripherals and the like, securing an area in which compressed files can be expanded in RAM is problematic. On the other hand, since multifunction peripherals need to implement complex image processing, a relatively large capacity nonvolatile memory is provided in order to temporarily store intermediate image data when performing image processing. This nonvolatile memory can be used as an expansion area during update, since the nonvolatile memory is not used as long as the update process is not contending with other processing such as image forming. There are, however, constraints on the size of nonvolatile memory, so that even if the update process is not contending with other processing, it may not be possible to expand all of the difference files at the same time.

Also, even in an information processing apparatus that does not use a compressed file system, the update process could possibly be interrupted before the firmware update is complete, thus making it desirable to back up firmware before update. However, it may also not be possible in this case to secure an area in nonvolatile memory for backing up firmware.

### SUMMARY OF THE INVENTION

The present invention has been made in consideration of the above problems, and provides an information processing apparatus capable of suppressing cost increases due to increases in the amount of storage capacity, and securing an area in which to expand compressed difference files, while at the same time preventing a situation in which a firmware update process contends with other processing, and a control method thereof.

According to one aspect of the present invention, there is provided an information processing apparatus provided with a nonvolatile memory that includes a first area for storing compressed firmware and a second area, comprising: a reception unit configured to receive, via a network, compressed difference files corresponding to respective regions of the firmware that are to undergo an update process; a selection unit configured to select a difference file of a size expandable in the second area, from the difference files received by the reception unit; a transition unit configured to transition to a state where no jobs are received except for the update process; an expansion unit configured to expand the difference file selected by the selection unit in the second area; and an execution unit configured to execute the update process on the firmware after the transition to the state by the transition unit, by compressing the difference file expanded by the expansion unit and storing the compressed difference file in the first area.

According to another aspect of the present invention, there is provided an information processing apparatus provided with a nonvolatile memory that includes a first area for storing a plurality of firmware and a second area, comprising: a reception unit configured to receive, via a network, files corresponding to respective firmware that is to undergo an update process; a transition unit configured to transition to a state where no jobs are received except for the update process; a selection unit configured to select firmware to undergo the update process, from a plurality of firmware stored in the first area; a control unit configured to perform control such that the firmware selected by the selection unit is moved from the first area to the second area, after the transition to the state by the transition unit; and an execution unit configured to execute the update process on the firmware, by storing the files received by the reception unit in the first area, in response to the firmware selected by the selection unit being moved from the first area to the second area, wherein the control unit, in a case where a size of the firmware selected by the selection unit is greater than a size of free space in the second area, erases data stored in the second area, such that the free space is greater than at least the size of the selected firmware.

According to still another aspect of the present invention, there is provided a control method of an information processing apparatus provided with a nonvolatile memory that includes a first area for storing compressed firmware and a second area, comprising the steps of: receiving, via a network, compressed difference files corresponding to respective regions of the firmware that are to undergo an update process; selecting a difference file of a size expandable in the second area, from the difference files received in the reception step; transitioning to a state where no jobs are received except for the update process; expanding the difference file selected in the selection step in the second area; and executing the update process on the firmware after the transition to the state in the transition step, by compressing the difference file expanded in the expansion step and storing the compressed difference file in the first area.

According to yet another aspect of the present invention, there is provided a control method of an information processing apparatus provided with a nonvolatile memory that includes a first area for storing a plurality of firmware and a second area, comprising the steps of: receiving, via a network, files corresponding to respective firmware that is to undergo an update process; transitioning to a state where no jobs are received except for the update process; selecting firmware to undergo the update process, from a plurality of firmware stored in the first area; performing control such that the firmware selected in the selection step is moved from the first area to the second area, after the transition to the state in the transition step; and executing the update process on the firmware, by storing the files received in the reception step in the first area, in response to the firmware selected in the selection step being moved from the first area to the second area, wherein the control step comprises, in a case where a size of the firmware selected in the selection step is greater than a size of free space in the second area, erasing data stored in the second area, such that the free space is greater than at least the size of the selected firmware.

The present invention enables provision of an information processing apparatus capable of suppressing cost increases due to increases in the amount of storage capacity, and securing an area in which to expand compressed difference files, while at the same time preventing a situation in which a firmware update process contends with other processing, and a control method thereof.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a configuration of an image input/output system according to Embodiment 1 of the present invention.

FIG. 2 shows an internal structure of an image forming apparatus.

FIG. 3 is a block diagram showing a detailed configuration of a control unit.

FIG. 4 conceptually shows a work area used in update.

FIG. 5 shows a processing procedure of the control unit.

FIG. 6 shows a processing procedure of the control unit according to Embodiment 2 of the present invention.

### DESCRIPTION OF THE EMBODIMENTS

Hereinafter, embodiments of the present invention will be described in detail with reference to the accompanying drawings. The embodiments described hereinafter are intended as example means for realizing the present invention, and the invention is applicable to configurations obtained through modifying or changing the following embodiments within a range that does not deviate from the gist thereof. For example, hereinafter, examples will be described in which an information processing apparatus according to the present invention is caused to function as a control apparatus that performs information processing in an image forming apparatus, but the present invention is not limited to these embodiments, and can be generally applied to a typical computer system.

### Embodiment 1

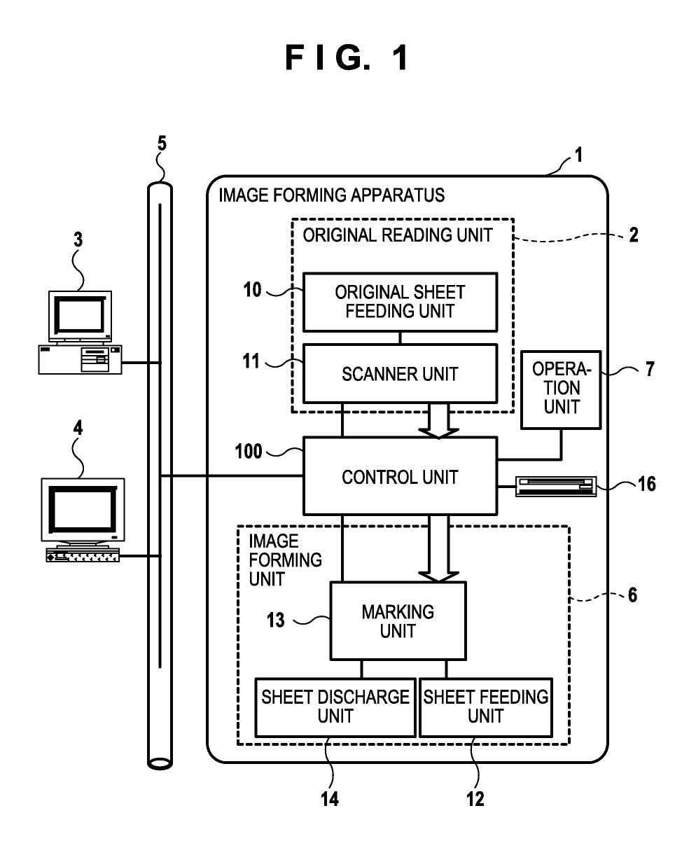

### Overall Configuration of Image Forming Apparatus 1 (FIG. 1)

The image forming apparatus 1 according to Embodiment 1 of the present invention is connected to host computers 3 and 4 via a LAN 5 (Local Area Network) such as an Ethernet (registered trademark).

The image forming apparatus 1 is provided with an original reading unit 2 that reads image data, an image forming unit 6 that outputs image data, an operation unit 7 provided with a keyboard for performing image data input/output operations, a liquid crystal panel for displaying image data and various functions, and the like, a storage unit 16 in which control programs, image data and the like are written in advance, and a control unit 100 that is connected to and controls these constituent elements.

The original reading unit 2 has an original sheet feeding unit 10 that conveys an original sheet targeted for reading, and a scanner unit 11 that optically reads an image on the conveyed original sheet and converts the read image to original image data constituting an electrical signal.

The image forming unit 6 has a sheet feeding unit 12 provided with a plurality of sheet feeding cassettes respectively housing sheets serving as output media of a plurality of types and sizes, a marking unit 13 that transfers and fixes image data to sheets, and a sheet discharge unit 14 that discharges printed sheets to the outside after sorting and/or stapling the printed sheets.

The control unit 100 has at least a scanner function of converting image data read by the original reading unit 2 to code and transmitting the code to the host computers 3 and 4 via the LAN 5, and an image forming function of converting code data received from the host computers 3 and 4 via the LAN 5 to image data and outputting the image data to the image forming unit 6. The control unit 100 functions as a sheet feeding control unit that controls the sheet feeding unit 12.

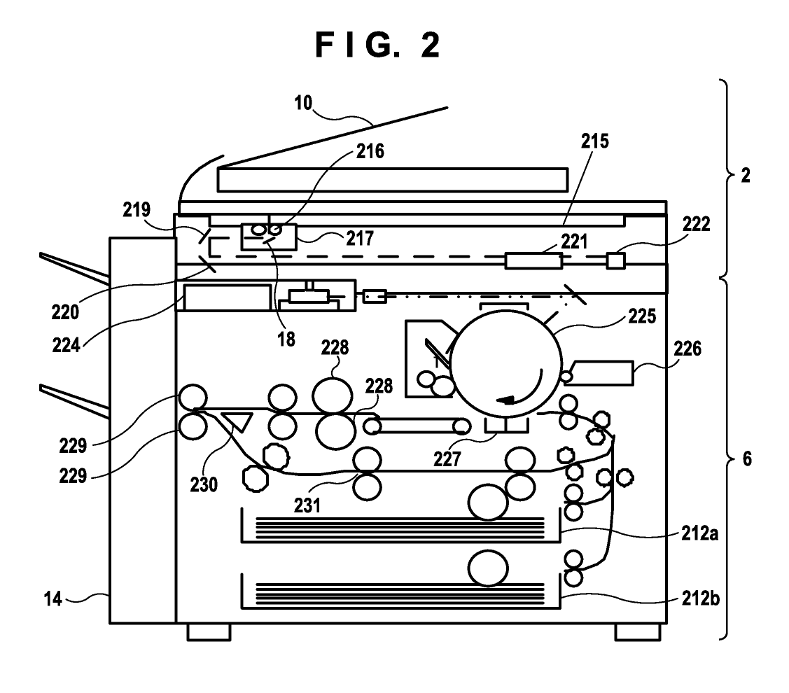

Detailed Configuration of Image Forming Unit 6 (FIG. 2)

In the original reading unit 2, original sheets stacked in an original sheet feeding unit 10 are fed one at a time sequentially from the leading sheet onto a platen glass 215. After the scanner unit 11 has finished a prescribed reading operation, the read original sheets are discharged from the platen glass 215 to the original sheet feeding unit 10. Also, in the scanner unit 11, a lamp 216 turns on when an original sheet is conveyed onto the platen glass 215, after which an optical unit 217 starts moving to a reading position.

The optical unit 217 irradiates a conveyed original sheet from below and scans the original sheet. Reflected light from the original sheet is guided to a CCD image sensor (hereinafter, simply “CCD”) 222 via a plurality of mirrors 218, 219, 220 and a lens 221, and the scanned original image is read by the CCD 222. Image data read by the CCD 222 is then transferred to the control unit 100 (not shown in FIG. 2) after undergoing prescribed processing. Alternatively, in the case of an original placed on an original platen, the lamp 216 is similarly turned on, after which the optical unit 217 starts moving, and the original sheet is irradiated from below and scanned, thereby enabling the scanned original sheet to be read by the CCD 222. Image data from the original reading unit 2 output as a result of the above procedure is received by the control unit 100 via a scanner connector 56.

Next, in the image forming unit 6, a laser beam corresponding to image data output from the control unit 100 is emitted from a laser emitting unit 224 that is driven by a laser driver 23 (not shown). An electrostatic latent image that depends on the laser beam is formed on a photoconductive drum 225 of the marking unit 13, and developer is adhered to the region of the electrostatic latent image by a developing device 226. Meanwhile, a recording sheet is fed from the sheet feeding unit 12 (sheet feeding cassettes 212a 212b) and conveyed to a transfer unit 227 in synchronous with the start of laser irradiation, and developer adhering to the photoconductive drum 225 is transferred to the recording sheet. The recording sheet to which the image data has been transferred is conveyed to a fixing unit 228, and the image data is fixed to the recording sheet by heat and pressure in the fixing unit 228.

In the case of recording image data on one side of a recording sheet, the recording sheet, having passed through the fixing unit 228, is discharged directly to the sheet discharge unit 214 by discharge rollers 229. The sheet discharge unit 214 sorts the discharged recording sheets into stacks, and staples the sorted recording sheets. In the case of recording image data on both sides of a recording sheet, the rotation direction of the discharge rollers 229 is reversed after the recording sheet is conveyed to the discharge rollers 229. Subsequently, the recording sheet, having been guided to a re-feeding conveyance path 231 by a flapper 230 and along the re-feeding conveyance path 231, is conveyed to the transfer unit 227 similarly to the above.

The control unit 100 is configured by a single electronic component as discussed above. The control unit 100 has a scanner function of converting image data read by the original reading unit 2 to code, and transmitting the code to the host computers 3 and 4 via the LAN 5. The control unit 100 further has other functional blocks, including a printer function of converting code data received from the host computers 3 and 4 via the LAN 5 to image data, and outputting the image data to the image forming unit 6.

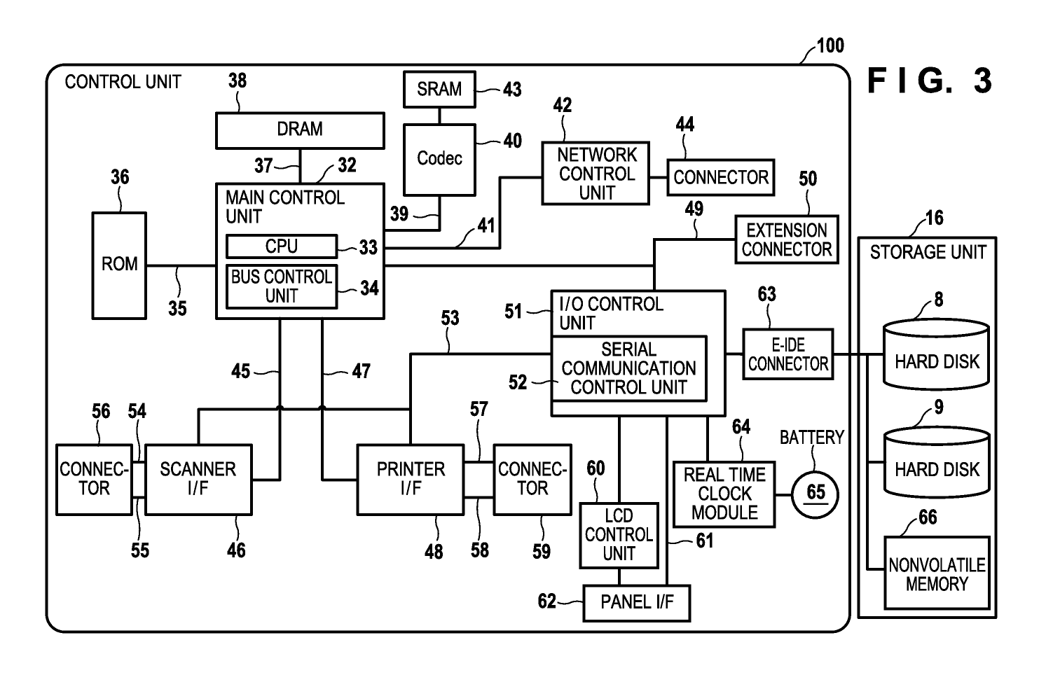

Detailed Configuration of Control Unit 100 (FIG. 3)

A main control unit 32 has a CPU 33, a bus control unit 34, and functional blocks including various control circuits that will be discussed later, and is connected to a ROM 36 via a ROM I/F 35, to a DRAM 38 via a DRAM I/F 37, to a codec 40 via a codec I/F 39, and to a network control unit 42 via a network control I/F 41.

The ROM 36 stores various control programs, operation data and the like executed by the CPU 33 of the main control unit 32. The DRAM 38 is used as a work area for the CPU 33 to perform operations, and an area for storing image data.

The codec 40 compresses raster image data stored in the DRAM 38 with a known compression method such as MH, MR, MMR or JBIG, and decompresses compressed data into a raster image. An SRAM 43 is connected to the codec 40, the SRAM 43 being used as a temporary work area for the codec 40. The network control unit 42 performs a prescribed control operation with the LAN 5 via a network connector 44.

The main control unit 32 is connected to a scanner I/F 46 via a scanner bus 45, to a printer I/F 48 via a printer bus 47, and further to an extension connector 50, which is for connecting an extension board, and an input/output control unit (I/O control unit) 51 via a generic high-speed bus 49 such as a PCI bus.

In the I/O control unit 51, an asynchronous serial communication control unit 52 for transmitting and receiving control commands to and from the original reading unit 2 and the image forming unit 6 is equipped with two channels, and the serial communication control unit 52 is connected to the scanner I/F 46 and the printer I/F 48 via an I/O bus 53.

The scanner I/F 46 is connected to a scanner connector 56 via an asynchronous serial I/F 54 and a video I/F 55, and the scanner connector 56 is connected to the scanner unit 11 of the original reading unit 2. The scanner I/F 46 performs a desired binary process and variable magnification in the main scan direction and the sub scan direction on image data received from the scanner unit 11, generates a control signal based on a video signal sent from the scanner unit 11, and transfers the control signal to the main control unit 32 via the scanner bus 45.

The printer I/F 48 is connected to a printer connector 59 via an asynchronous serial I/F 57 and a video I/F 58, and the printer connector 59 is connected to the marking unit 13 of the image forming unit 6. The printer I/F 48 performs smoothing on image data output from the main control unit 32 and outputs the image data to the marking unit 13, and further outputs a control signal generated based on a video signal sent from the marking unit 13 to the printer bus 47.

The CPU 33 operates based on a control program loaded from the ROM 36 via a ROM I/F 35, interpreting PDL (Page Description Language) data received from the host computers 3 and 4, and expanding the PDL data into raster image data, for example.

The bus control unit 34 controls data transfer with external devices connected to the scanner I/F 46, the printer I/F 48, the extension connector 50 and the like, and controls arbitration when bus contention occurs, DMA data transfer and the like. For example, data transfer between the abovementioned DRAM 38 and codec 40, data transfer from the scanner unit 11 to the DRAM 38, and data transfer from the DRAM 38 to the marking unit 13 are controlled by the bus control unit 34 and performed by DMA.

The I/O control unit 51 is connected to the operation unit 7 via a LCD control unit 60 and a panel I/F 62. The I/O control unit 51 is connected to hard disk drives 8 and 9 and a nonvolatile memory 66 via an E-IDE connector 63. The nonvolatile memory 66 is a memory capable of holding the storage content of data even during power off, and a writable flash memory or EEPROM can be used, for example. The nonvolatile memory 66 stores various control programs for controlling the main control unit 32.

Further, the I/O control unit 51 is connected to a real time clock module 64 that updates/holds the date and time managed in the device. Note that the real time clock module 64 is connected to a backup battery 65 and backed up by the backup battery 65.

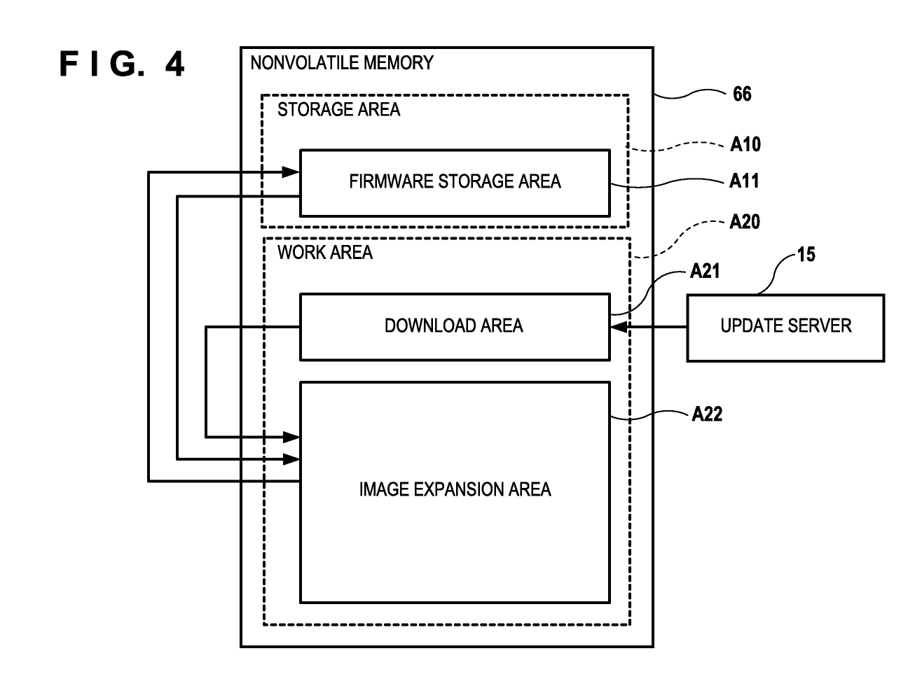

Partitioning of Nonvolatile Memory (FIG. 4)

The nonvolatile memory 66 is functionally partitioned into a storage area A10 (first area) for storing compressed firmware and a work area A20 (second area) for temporarily storing intermediate data for image processing. Note that the nonvolatile memory 66 may be two memories that are physically partitioned.

The storage area A10 has a firmware storage area A11, which is an area for storing various types of control programs of the image forming apparatus. Included in the various types of control programs is firmware for interpreting PDL data and expanding the PDL data into raster image data. Also included is firmware for controlling jobs such as print jobs and copy jobs. The firmware storage area A11, being a compressed file system, is normally operated as a read-only area in which arbitrary files cannot be directly edited with a normal write system call or the like. On the other hand, the firmware storage area A11 is rewritable during update.

The work area A20, being a generic file system, is an area that can be read and written as a normal directory, and is used for holding various data. The work area A20 has a download area A21 for storing packages used in update, and an image expansion area A22.

Here, a package is distribution firmware, and specifically has been compressed with a generic compression algorithm such as ZIP in order to reduce size, and includes files for update and various types of metadata information attached to files. At least one difference file is included in a package, and packages can be partitioned per function by dividing the control module into dynamic-link library files for each function. For example, in the case where there is a problem with an image processing function, problem correction can be reflected by targeting an image processing function package for update. Similarly, a communication function can be partitioned as a package, and in the case where security vulnerability is found in the communication function, vulnerability response can be reflected by targeting a communication function package for update.

Note that the compression algorithm used internally by the compression file system according to the present Embodiment 1 is assumed to be a generic algorithm such as ZIP, and here is the same compression algorithm employed by the packages. The size of the download area A21 is assumed to be greatest in the case where an entire piece of firmware is targeted for update, in which case the download area A21 is expanded to the same size as the firmware storage area A11. In Embodiment 1, since background downloading during normal operation is implemented, the download area A21 is constantly securable at the same size as the firmware storage area A11.

Downloading can be implemented from a plurality of systems such as an external server or removable media such as a USB, and here downloads are transferred from an update server 15. Known techniques are assumed to be used for the actual transfer sequence and the like.

The image expansion area A22 is used during normal operation for storing intermediate data for image processing, and is used during update as an area for expanding and placing packages stored in the download area A21. Since the image expansion area A22 is used exclusively during normal operation and update, a normal mode and an update mode are provided as device states.

In the update mode, the control module is set to a configuration in which jobs cannot be input from a network or user interface, so as to not accept any print, copy or other jobs. If intermediate data or the like remains in the image expansion area A22 in the update mode, these files are deleted during the update sequence, since they are no longer needed.

Firmware placed in the firmware storage area A11 is virtually placed on a placement path of the image expansion area A22, by implementing UnionFS or the like in the image expansion area A22. Further, an updated firmware image is created by performing processing such as overwriting on the image expansion area A22 to reflect the files included in a package. Further, update of firmware can be realized by converting the updated firmware image to a compressed file system, and replacing the pre-update compressed file system placed in the firmware storage area A11.

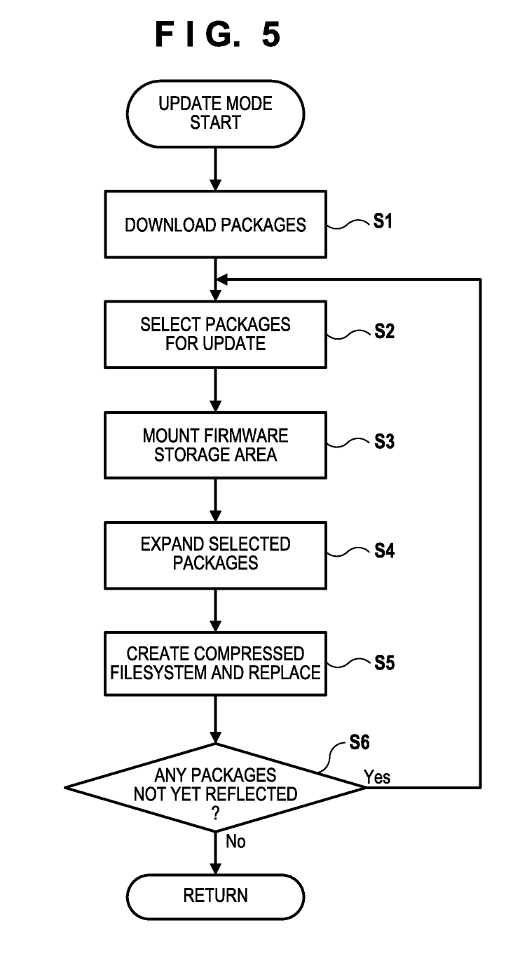

Update Procedure of Control Unit 100 (FIG. 5)

The control unit 100 transitions to the update mode at various timings in response to, for instance, an instruction from a user interface, an instruction via a network, and an instruction due to prior schedule settings, and starts the update process, which constitutes interrupt processing. If, at the time of mode transition, the user need only rewrite device settings, the apparatus may need to be restarted in addition to the device settings being rewritten.

When the update mode is started, the control unit 100 firstly downloads packages (firmware) for performing the update from the update server 15, and stores the downloaded packages in the download area A21 (S1). Note that enough storage area for storing downloaded packages is allocated in advance to the work area A20.

The control unit 100 selects a combination of packages that is expandable in the image expansion area A22 (S2). In actual fact, the best compression ratio of the algorithm used in compression is posited, and the expanded size is estimated from the size of the package. For example, if a compression algorithm with a best compression ratio of 25% is employed, it is posited that an area four times the size of the package will be required after expansion.

Note that a configuration may be adopted in which information indicating the uncompressed size of the package, the compression ratio or the like is provided as metadata of the package when creating the package. Also, any algorithm may be used as the algorithm for selecting a combination of packages expandable in the image expansion area A22, based on this information indicating size, compression ratio or the like. For example, an algorithm is conceivable that selects packages sequentially in descending order of size, and ends the selection process in a range in which the total size of the packages is expandable within the size of the image expansion area A22.

Assume, for example, that a 64 MB area is allocated as the image expansion area A22. Assume also that the downloaded packages include four pieces of compressed firmware A, B, C and D. Assume further that the decompressed size of firmware A is 32 MB, the decompressed size of firmware B is 16 MB, the decompressed size of firmware C is 16 MB, and the decompressed size of firmware D is 16 MB. In this case, the control unit 100, in step S2, selects A, B and C (total size of 64 MB) expandable within the size (64 MB) of the image expansion area A22. The control unit 100 then selects firmware D when S2 is again executed after S6.

Next, the control unit 100 uses UnionFS or the like to virtually place the firmware of the firmware storage area A11 on a directory path on which the image expansion area A22 is placed (S3). The packages selected at step S2 are expanded in the image expansion area A22 (S4). Here, the expanded files are prevented from being targeted again for expansion, by storing information on the selected packages in a table, deleting the actual packages from the download area A21, or the like. Here, expanded files are removed as targets for expansion by deleting the actual packages.

Next, the control unit 100 creates a compressed file system by compressing the files expanded in the image expansion area A22 in directory units, and replaces the compressed file system placed in the firmware storage area A11 (S5). The control unit 100 then determines whether there are any packages in the download area A21 that have yet to be reflected.

If there are packages that have yet to be reflected, the control unit 100 returns to step S2, and if there are no packages that have yet to be reflected, the control unit 100 ends the update process by transitioning from the update mode to the normal mode, and continues operating in a normal state in which jobs can be accepted.

As discussed above, according to Embodiment 1, security vulnerability can be reduced by enabling network update to be executed cost-effectively and quickly.

### Embodiment 2

In Embodiment 1, firmware stored in the firmware storage area is in compressed format, whereas Embodiment 2 differs in that this firmware is in uncompressed format. Also, in Embodiment 1, packages (firmware) downloaded from an update server are in compressed format, whereas Embodiment 2 differs in that these packages are in uncompressed format. Note that Embodiment 2 is a variation of Embodiment 1, and, apart from the portions that will in particular be described below, is assumed to be similar to Embodiment 1

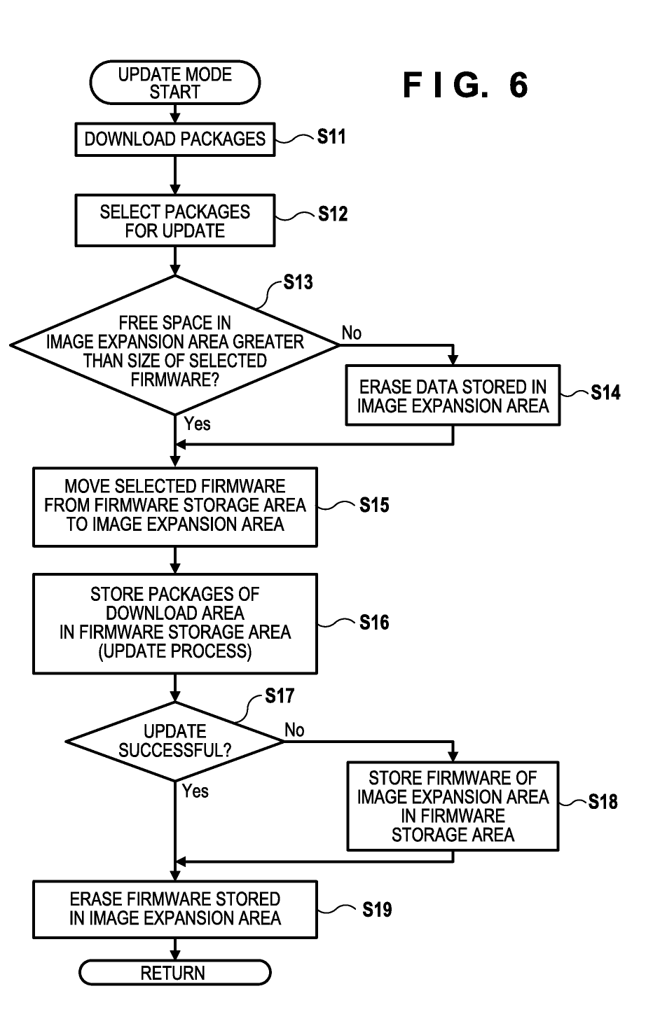

Update Procedure of Control Unit 100 (FIG. 6)

The control unit 100 transitions to the update mode at various timings in response to, for instance, an instruction from a user interface, an instruction via a network, and an instruction due to prior schedule settings, and starts the update process, which constitutes interrupt processing. If, at the time of mode transition, the user need only rewrite device settings, the apparatus may need to be restarted in addition to the device settings being rewritten.

When the update mode is started, the control unit 100 firstly downloads packages (firmware) for performing the update from the update server 15, and stores the downloaded packages in the download area A21 (S11).

The control unit 100 then selects firmware to be targeted for update, with reference to the downloaded packages (S12). For example, if the downloaded packages are firmware A and B, the firmware A and B are selected.

Subsequently, the control unit 100 determines whether the free space of the image expansion area A22 is greater than the size of the firmware selected at S12 (S13). For example, if the firmware A and B are selected at S12, the size of the firmware will be 48 MB (32 MB+16 MB), thus the control unit 100 determines whether the free space of the image expansion area A22 is greater than 48 MB.

If the free space of the image expansion area A22 is greater than the size of the firmware selected at S12, the control unit 100 proceeds to S15, without performing S14. On the other hand, if the free space of the image expansion area A22 is less than or equal to the size of the firmware selected at S12, the control unit 100 erases data stored in the image expansion area A22, such that the free space of the image expansion area A22 is at least greater than the size of the firmware selected at S12 (S14), and then proceeds to S15.

Note that when erasing data from the image expansion area A22, data that will have little impact when erased is preferentially erased. For example, data stored in the image expansion area A22 as cache data when executing the firmware A is preferentially erased.

The control unit 100 then moves the firmware selected at S12 from the firmware storage area A11 to the image expansion area A22 in order to backup the firmware (S15).

Note that at the time of this move, the firmware may firstly be copied to the image expansion area A22, and the copied firmware may then be erased from the firmware storage area A11 after the copying is successfully completed, in order to allow for any problems such as power to the image forming apparatus 1 being cut during the move.

The control unit 100 then stores the packages (firmware) stored in the download area A21 at S11 to the firmware storage area A11 (S16). As a result of this update process, firmware stored in the firmware storage area A11 is updated.

The control unit 100 then determines whether the update process of S16 was successful (S17). If the update process was successful, the control unit 100 proceeds to S19, without performing S18. On the other hand, if it is determined that the update process failed, the control unit 100 stores the firmware backed up in the image expansion area A22 to the firmware storage area A11 (S18), and proceeds to S19. As a result of this processing, pre-update firmware is restored in the firmware storage area A11.

The control unit 100 then erases the firmware backed up in the image expansion area A22 (S19), and ends the flow of the series of processes depicted in FIG. 6.

As discussed above, according to Embodiment 2, security vulnerability can be reduced by enabling network update to be executed cost-effectively and quickly. Also, the amount of data stored in the image expansion area A22 to be erased can be minimized, even in the case where the free space of the image expansion area A22 is less than or equal to the size of firmware targeted for update.

Accordingly, the processing speed when executing firmware using data stored in the image expansion area A22 can be kept from dropping as a result of the update process on firmware.

### Other Embodiments

Aspects of the present invention can also be realized by a computer of a system or apparatus (or devices such as a CPU or MPU) that reads out and executes a program recorded on a memory apparatus to perform the functions of the above-described embodiment(s), and by a method, the steps of which are performed by a computer of a system or apparatus by, for example, reading out and executing a program recorded on a memory apparatus to perform the functions of the above-described embodiment(s). For this purpose, the program is provided to the computer for example via a network or from a recording medium of various types serving as the memory apparatus (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-001565, filed Jan. 6, 2010, which is hereby incorporated by reference herein in its entirety.

What is claimed is:

1. An information processing apparatus provided with a nonvolatile memory that includes a first area for storing compressed firmware and a second area, comprising:
a reception unit configured to receive, via a network, compressed difference files corresponding to respective regions of the firmware that are to undergo an update process;
a selection unit configured to select a difference file of a size expandable in the second area, from the difference files received by the reception unit;
a transition unit configured to transition to a state where no jobs are received except for the update process;
an expansion unit configured to expand the difference file selected by the selection unit in the second area; and
an execution unit configured to execute the update process on the firmware after the transition to the state by the transition unit, by compressing the difference file expanded by the expansion unit and storing the compressed difference file in the first area.

2. The information processing apparatus according to claim 1, wherein the second area includes an area for storing all of the difference files received by the reception unit, and an area in which the expansion unit expands the difference file selected by the selection unit.

3. The information processing apparatus according to claim 1,
wherein each of the difference files includes information indicating an uncompressed size of the difference file, and
the selection unit selects a difference file of a size expandable in the second area, based on the information indicating the uncompressed size.

4. The information processing apparatus according to claim 1,
wherein each of the difference files includes information indicating a compression ratio of the difference file, and
the selection unit selects a difference file of a size expandable in the second area, based on the information indicating the compression ratio.

5. The information processing apparatus according to claim 1, further comprising an image processing unit configured to process image data,
wherein the second area is an area for storing image data that has been image processed by the image processing unit.

6. A storage medium storing a program for causing a computer to function as the units of the information processing apparatus according to claim 1.

7. An information processing apparatus provided with a nonvolatile memory that includes a first area for storing a plurality of firmware and a second area, comprising:
a reception unit configured to receive, via a network, files corresponding to respective firmware that is to undergo an update process;
a transition unit configured to transition to a state where no jobs are received except for the update process;
a selection unit configured to select firmware to undergo the update process, from a plurality of firmware stored in the first area;
a control unit configured to perform control such that the firmware selected by the selection unit is moved from the first area to the second area, after the transition to the state by the transition unit; and
an execution unit configured to execute the update process on the firmware, by storing the files received by the reception unit in the first area, in response to the firmware selected by the selection unit being moved from the first area to the second area,
wherein the control unit, in a case where a size of the firmware selected by the selection unit is greater than a size of free space in the second area, erases data stored in the second area, such that the free space is greater than at least the size of the selected firmware.

8. A storage medium storing a program for causing a computer to function as the units of the information processing apparatus according to claim 7.

9. A control method of an information processing apparatus provided with a nonvolatile memory that includes a first area for storing compressed firmware and a second area, comprising the steps of:
receiving, via a network, compressed difference files corresponding to respective regions of the firmware that are to undergo an update process;
selecting a difference file of a size expandable in the second area, from the difference files received in the reception step;
transitioning to a state where no jobs are received except for the update process;
expanding the difference file selected in the selection step in the second area; and
executing the update process on the firmware after the transition to the state in the transition step, by compressing the difference file expanded in the expansion step and storing the compressed difference file in the first area.

10. A control method of an information processing apparatus provided with a nonvolatile memory that includes a first area for storing a plurality of firmware and a second area, comprising the steps of:
receiving, via a network, files corresponding to respective firmware that is to undergo an update process;
transitioning to a state where no jobs are received except for the update process;
selecting firmware to undergo the update process, from a plurality of firmware stored in the first area;
performing control such that the firmware selected in the selection step is moved from the first area to the second area, after the transition to the state in the transition step; and
executing the update process on the firmware, by storing the files received in the reception step in the first area, in response to the firmware selected in the selection step being moved from the first area to the second area,
wherein the control step comprises, in a case where a size of the firmware selected in the selection step is greater than a size of free space in the second area, erasing data stored in the second area, such that the free space is greater than at least the size of the selected firmware.
